(19) United States
(12) Patent Application Publication
(10) Pub. No.: US 2025/0279903 A1
(43) Pub. Date: Sep. 4, 2025

(54) SYSTEMS AND METHODS FOR IDENTIFYING ACTIVITIES OF INDIVIDUALS IN VIRTUAL SPACES USING SIDECHAINS

(71) Applicant: Wells Fargo Bank, N.A., San Francisco, CA (US)

(72) Inventors: Jeff J. Stapleton, O'Fallon, MO (US); Michael Knorr, Fairfield, CT (US); Sadie S. Salim, Mill Valley, CA (US); Manesh Saini, New York City, NY (US)

(21) Appl. No.: 18/046,602

(22) Filed: Oct. 14, 2022

(51) Int. Cl. H04L 9/00

(52) U.S. Cl. CPC H04L 9/50

(57) ABSTRACT

Systems, apparatuses, methods, and computer program products are disclosed for identifying how individuals traverse through virtual spaces. An example method includes identifying relevant data from blockchains associated with virtual spaces and harvesting the relevant data from the blockchains. The example method further includes storing the harvested data in organized sidechains for accessibility, and based on the stored data of the sidechains, generate outputs.

### BACKGROUND

Virtual spaces (e.g., such as the metaverse) are computer-simulated places and/or environments with which users can interact via an interface (e.g., a computing device). As individuals spend more time within virtual spaces, these virtual spaces have become a valuable source for user-related information.

### BRIEF SUMMARY

The metaverse presents new challenges in identifying where and how individuals have traversed through virtual spaces. The use of digital avatars and encoding of configuration, modification, and general information in proprietary, standardized, or potentially blockchain formats obfuscates such traversal actions of people within such virtual spaces. To address these challenges is to facilitate management, including generation and deployment, of “footprint data” to identify individuals or activity of individuals within these virtual spaces. As one example, sidechains may be generated and used to establish associations between an individual and data within a blockchain (e.g., a primary blockchain) or other representation of a virtual space. Such sidechains may be implemented as another blockchain (e.g., a blockchain separate from a primary blockchain) that operates independently and in parallel with one or more primary blockchains on which information regarding one or more virtual spaces are encoded. Additionally, these sidechains may be populated via an application or interpreter (discussed in more detail below as Interpreter 102 of FIG. 1) that reads a primary blockchain as it is populated with information regarding the individual's activity in a virtual space. Detailed examples of a configuration including virtual spaces, primary blockchains, and sidechain are shown below in reference to FIGS. 4A-4C. By establishing one sidechain for an individual, an immutable rendition of that individual's activity within a virtual space may advantageously be established. The sidechain may also be used in many different types of downstream processes that uses the individual's behavior in the metaverse (or other types of virtual spaces) to make one or more determinations about the individual.

Systems, apparatuses, methods, and computer program products are disclosed herein for generating one or more sidechains to store (e.g., in a decentralized network) harvested footprint data representing activities of individuals in virtual spaces. In some embodiments, the footprint data stored in the generated sidechains may advantageously be used to make inferences concerning behaviors of the individuals within these virtual spaces. The sidechains may be stored on a shared database in the decentralized network, reserving computing resources of a user's computing device that may have been limited if not for the utilization of the shared database. The storage of the sidechains in the shared database may also grant easier accessibility to data associated with virtual identities (e.g., due to footprint data being organized and condensed into sidechains). Harvesting footprint data may also lead to more efficient use (i.e., an improved use) of useful data within virtual spaces that may otherwise be underutilized (or not utilized at all). In some embodiments, the footprint data stored in sidechains is used to identify behaviors (also referred to herein as “activity information”) of individuals in these virtual spaces.

As a result, the sidechains of some embodiments not only improve computer functionality by reducing the amount of computing resources required by a single computer to store all data within each sidechain, but also improves the technical field of virtual reality technology by providing an improved mechanism that better tracks and utilizes data (i.e., resources of information) dispersed throughout these virtual spaces.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 shows a block diagram illustrating a system in accordance with an embodiment.

FIG. 2 illustrates a schematic block diagram of example circuitry embodying a device that may perform various operations in accordance with some example embodiments described herein.

FIG. 3 illustrates an example flowchart for generating a sidechain, in accordance with some example embodiments described herein.

FIGS. 4A-4C illustrate implementation examples in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server. A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device, such as a smart phone, thereby enabling it to function as an Internet server (e.g., an enterprise e-mail server) only to the extent necessary to provide the functionality described herein.

### Overview

As noted above, methods, apparatuses, systems, and computer program products are described herein that provide means for generating sidechains for tracking one or more individual's behavior across one or more primary blockchains (e.g., the metaverse, Decentraland, etc.). Traditionally, it has been very difficult and almost impossible to track activities of individuals across various virtual spaces. In particular, each individual may have multiple identities (e.g., avatars) across each of these virtual spaces, and an association between the multiple identities of a single individual is not always clear or provided. Said another way, it is difficult (and almost impossible due to the anonymity afforded by the metaverse) to directly associate a first identity of an individual in one virtual space to a second identity of the individual in a different virtual space. It is also difficult to retain such anonymity afforded by the metaverse while trying to track (e.g., link, associate, etc.) all of an individual's identities within the metaverse.

In contrast to conventional techniques for tracking an individual across multiple spaces (e.g., cities, towns, across the world, within Internet spaces, etc.), example embodiments described herein may generate sidechains for tracking an individual across one or more primary blockchains. These primary blockchains may have information of the individual (e.g., transactional information, conversations, interactions with other individuals, etc.) that make these primary blockchains good representations of the individual's behavior within these primary blockchains. An application or interpreter may be configured to obtain (e.g., receive, retrieve, etc.) such behavioral information of the individual (referred to herein as an individual's “footprint data”) from these primary blockchains. The footprint data obtained from different primary blockchains may be associated with another. In some embodiments, this association of the footprint data from different primary blockchains is secured in the sidechain in which it is stored and not provided back to the primary blockchains. More specifically, the primary blockchains are not provided with data that could associate an individual's first identity in a first primary blockchain of the primary blockchains to any of the individual's other identities in primary blockchains aside from the first primary blockchain. Said another way, none of the primary blockchains are provided with data that could link together the individual's identities in these primary blockchains.

In some embodiments, the obtained footprint data may be stored (e.g., after the association is completed) into a sidechain that is instantiated (e.g., generated, created, etc.) to store the associated footprint data. As discussed above, each of the individual's identities across the primary blockchains may include footprint data that reflects the individual's behavior and activities across the primary blockchains. As a result, embodiments disclosed herein are advantageously able to not only effectively and accurately track an individual across one or more primary blockchains but also retain the individual's anonymity within these primary blockchains.

In some embodiments, a single sidechain may be dedicated to a single individual. Alternatively, a single sidechain may be used for multiple different individuals. For example, footprint data of a first individual's identity may also be associated with footprint data of a second individual's identity across the primary blockchains. More specifically, the first individual may be a child and the second individual may be the child's guardian (e.g., parents, grandparents, etc.). Such association may advantageously provide the child with a trust level associated with the child's guardian. For example, the child is given the guardian's payment information (e.g., credit card information). Such an association can then allow a merchant (e.g., a bank, a credit card company, a business, etc.) processing a transaction by the child to determine that the child is associated with the guardian who may be a trusted client of the merchant.

In some embodiments, as information (e.g., the footprint data) is organized into these sidechains, the information may be output to one or more entities (e.g., a bank, a company, another individual, etc.) to allow these entities to better understand the individual's behavior across the primary blockchains. This advantageously allows embodiments disclosed herein to help these entities make more informed and accurate decisions with regard to the individual. For example, a bank may harvest a client's footprint data across respective primary blockchains to allow the bank to make more informed and accurate decision with regard to products (e.g., services) offered to the client. For example, the footprint data may indicate a risk level of an individual that can then be translated to how the individual handles his/her finances.

Although a high-level explanation of the operations of example embodiments has been provided above, specific details regarding the configuration of such example embodiments are provided below.

### System Architecture

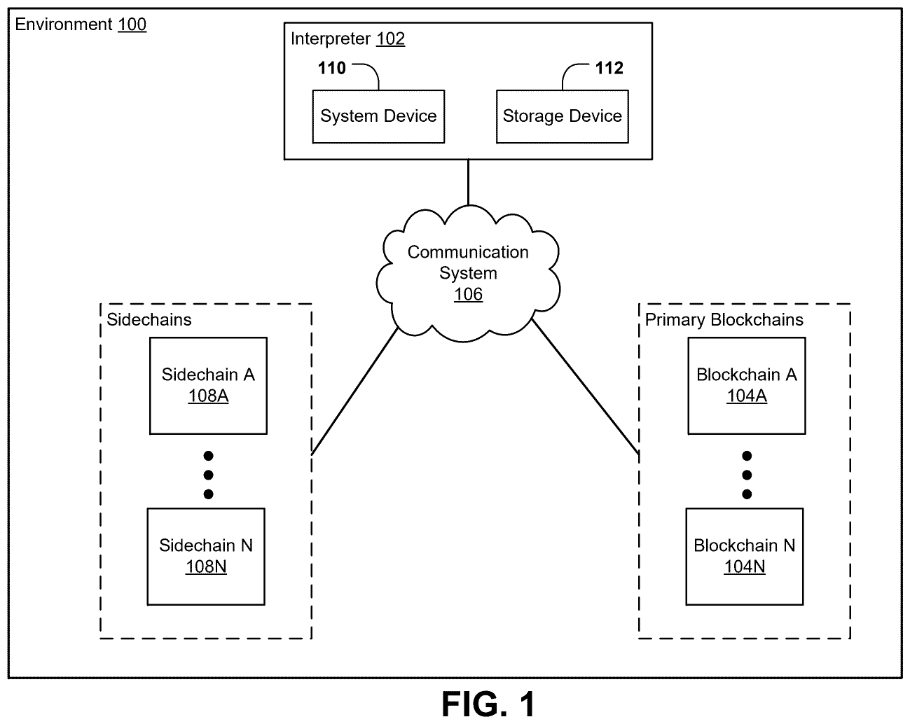

Example embodiments described herein may be implemented using any of a variety of computing devices or servers. To this end, FIG. 1 illustrates an example environment 100 within which various embodiments may operate. As illustrated, an interpreter 102 may include a system device 110 in communication with a storage device 112. Although system device 110 and storage device 112 are described in singular form, some embodiments may utilize more than one system device 110 and/or more than one storage device 112. Additionally, some embodiments of the interpreter 102 may not require a storage device 112 at all. Whatever the implementation, the interpreter 102, and its constituent system device(s) 110 and/or storage device(s) 112 may receive and/or transmit information via communication system 106 (e.g., the internet) with any number of other devices, such as one or more of blockchain 104A through blockchain 104N and/or sidechain 108A through sidechain 108N.

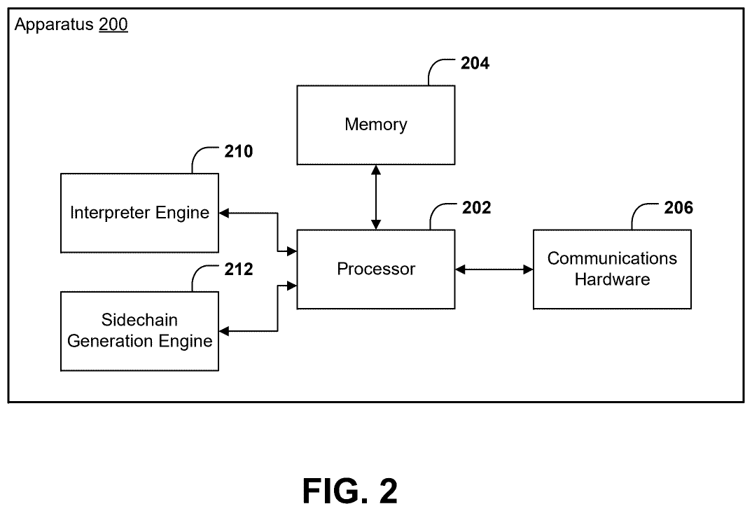

System device 110 may be implemented as one or more servers, which may or may not be physically proximate to other components of interpreter 102. Furthermore, some components of system device 110 may be physically proximate to the other components of interpreter 102 while other components are not. System device 110 may receive, process, generate, and transmit data, signals, and electronic information to facilitate the operations of interpreter 102. Components of system device 110 are described in greater detail below with reference to apparatus 200 in connection with FIG. 2.

Storage device 112 may comprise a distinct component from system device 110, or may comprise an element of system device 110 (e.g., memory 204, as described below in connection with FIG. 2). Storage device 112 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 106). Storage device 112 may host the software executed to operate interpreter 102. Storage device 112 may store information relied upon during operation of the interpreter 102, such as various instructions that may be used by interpreter 102, data and documents to be analyzed using interpreter 102, or the like. In addition, storage device 112 may store control signals, device characteristics, and access credentials enabling interaction between interpreter 102 and one or more of the primary blockchains 104A-104N and/or sidechains 108A-108N.

The one or more primary blockchains 104A-104N are data structures embodied, at least in part, by any number of storage devices (e.g., in a decentralized network) connected through communication system 106 (e.g., the Internet). Said another way, each of the one or more primary blockchains 104A-104N is a distributed database or ledger that is shared among the nodes of a (decentralized) computer network. These data structures may host one or more virtual spaces in the form of one or more primary blockchains. Each of the primary blockchains 104A-104N may be a series of data blocks that are chained (e.g., linked) together.

The one or more sidechains 108A-108N, like primary blockchains 104A-104N, are also data structures embodied, at least in part, by any number of storage devices (e.g., in a decentralized network) connected through communication system 106. Each of the sidechains 108A-108N may be a series of data blocks that are chained (e.g., linked) together. In some embodiments, a sidechain of the sidechains 108A-108N may only include a single data block. In the context of embodiments disclosed herein, a “sidechain” is a blockchain that is stored next to a primary blockchain as a supplement of the primary blockchain (e.g., is a data structure for storing data that supplements data in one or more primary blockchains).

Although FIG. 1 illustrates an environment and implementation in which the interpreter 102 interacts with one or more of the primary blockchains 104A-104N and/or the sidechains 108A-108N, in some embodiments users may directly interact with the interpreter 102 (e.g., via input/output circuitry of system device 110), in which case a separate one of the primary blockchains 104A-104N may, or may not, be utilized. If by way of direct interaction, then a user may communicate with, operate, control, modify, or otherwise interact with the interpreter 102 to perform the various functions and achieve the various benefits described herein.

### Example Implementing Apparatuses

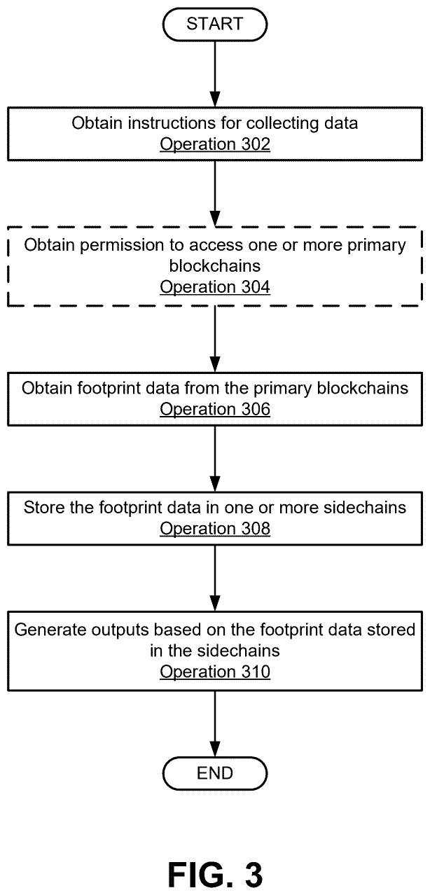

System device 110 of interpreter 102 (described previously with reference to FIG. 1) may be embodied by one or more computing devices or servers, shown as apparatus 200 in FIG. 2. As illustrated in FIG. 2, the apparatus 200 may include processor 202, memory 204, communications hardware 206, input-output circuitry of the communications hardware 206, interpreter engine 210, and sidechain generation engine, each of which will be described in greater detail below. While the various components are only illustrated in FIG. 2 as being connected with processor 202, it will be understood that the apparatus 200 may further comprise a bus (not expressly shown in FIG. 2) for passing information amongst any combination of the various components of the apparatus 200. The apparatus 200 may be configured to execute various operations described above in connection with FIG. 1 and below in connection with FIG. 3.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor (e.g., software instructions stored on a separate storage device 112, as illustrated in FIG. 1). In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processor for causing transmission of such signals to a network or for handling receipt of signals received from a network. In some embodiments, the communications hardware 206 may include, for example, interfaces such as one or more ports (e.g., a laser port, a fiber-optic cable port, and/or the like) for enabling communications with other devices.

The communications hardware 206 may include input-output circuitry (not shown) configured to provide output to a user and, in some embodiments, to receive an indication of user input. It will be noted that some embodiments will not include input-output circuitry, in which case user input may be received via a separate device such as a separate client device or the like. The input-output circuitry of the communications hardware 206 may comprise a user interface, such as a display, and may further comprise the components that govern use of the user interface, such as a web browser, mobile application, dedicated client device, or the like. In some embodiments, the input-output circuitry may include a keyboard, a mouse, a touch screen, touch areas, soft keys, a microphone, a speaker, and/or other input/output mechanisms. The input-output circuitry may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises an interpreter engine 210 configured to obtain footprint data from one or more primary blockchains (e.g., primary blockchains 104A-104N in FIG. 1). The interpreter engine 210 may also be configured to generate outputs based on footprint data stored in one or more sidechains. The interpreter engine 210 may utilize processor 202, memory 204, or any other hardware component included in the apparatus 200 to perform these operations, as described in connection with FIG. 3 below. The interpreter engine 210 may further utilize communications hardware 206 to gather data from a variety of sources (e.g., blockchain 104A through blockchain 104N or storage device 106, as shown in FIG. 1), may utilize input-output circuitry of the communications hardware 206 to receive data from a user, and in some embodiments may utilize processor 202 and/or memory 204 to identify relevant information from the variety of sources to be gathered.

Finally, the apparatus 200 further comprises a sidechain generation engine 212 configured to instantiate sidechains (e.g., sidechains 108A-108N in FIG. 1) and store information obtained by the interpreter engine 210 in the instantiated sidechains. The sidechain generation engine 212 may utilize processor 202, memory 204, or any other hardware component included in the apparatus 200 to perform these operations, as described in connection with FIG. 3 below. The sidechain generation engine 212 may further utilize communications hardware 206 to gather data from a variety of sources (e.g., interpreter engine 210 or storage device 112, as shown in FIG. 1), may utilize input-output circuitry of the communications hardware 206 to receive data from a user, and in some embodiments may utilize processor 202 and/or memory 204 to instantiate the sidechains and store information in the sidechains.

Although components 202-212 are described in part using functional language, it will be understood that the particular implementations necessarily include the use of particular hardware. It should also be understood that certain of these components 202-212 may include similar or common hardware. For example, the interpreter engine 210 and the sidechain generation engine 212 may each at times leverage use of the processor 202, memory 204, communications hardware 206, or input-output circuitry of communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry,” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the interpreter engine 210 and the sidechain generation engine 212 may leverage processor 202, memory 204, communications hardware 206, or input-output circuitry of the communications hardware 206 as described above, it will be understood that any of these elements of apparatus 200 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or memory 204, communications hardware 206 or input-output circuitry of communications hardware 206 for enabling any functions not performed by special-purpose hardware elements. In all embodiments, however, it will be understood that the interpreter engine 210 and the sidechain generation engine 212 are implemented via particular machinery designed for performing the functions described herein in connection with such elements of apparatus 200.

In some embodiments, various components of the apparatuses 200 may be hosted remotely (e.g., by one or more cloud servers) and thus need not physically reside on the corresponding apparatus 200. Thus, some or all of the functionality described herein may be provided by third party circuitry. For example, a given apparatus 200 may access one or more third party circuitries via any sort of networked connection that facilitates transmission of data and electronic information between the apparatus 200 and the third party circuitries. In turn, that apparatus 200 may be in remote communication with one or more of the other components describe above as comprising the apparatus 200.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a flowchart.

### Example Operations

Turning to FIG. 3, an example flowchart is illustrated that contains example operations implemented by example embodiments described herein. The operations illustrated in FIG. 3 may, for example, be performed by system device 110 of the interpreter 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, input-output circuitry of communications hardware 206, interpreter engine 210, sidechain generation engine 212, and/or any combination thereof.

It will be understood that user interaction with the interpreter 102 may occur directly via input-output circuitry of communications hardware 206, as shown in FIG. 2, or may instead be facilitated by an entity, such as a separate computing device, not expressly shown in FIGS. 1-2, and which may have similar or equivalent physical componentry facilitating such user interaction.

Turning to FIG. 3, example operations are shown for generating sidechains to track one or more individual's behavior across one or more primary blockchains (e.g., the metaverse, Decentraland, etc.).

As shown by operation 302, the apparatus 200 includes means, such as communications hardware 206, or the like, for obtaining instructions to collect data from a source. The source may be one or more primary blockchains (e.g., primary blockchains 104A-104N of FIG. 1). The instructions may be received directly and/or indirectly by the communications hardware 206 from a user of the apparatus 200. For example, the user may be directly operating the apparatus 200 and providing the instructions using one or more input-output circuitry of the communications hardware 206 (e.g., providing the instructions via a combination of a mouse, keyboard, and a graphical user interface (GUI) of the apparatus 200). Alternatively, the user may be transmitting the instructions from a separate computing device connected to the apparatus 200 (namely, the communications hardware 206) via communication system (e.g., communication system 106 in FIG. 1).

In some embodiments, the instructions may include information such as, but not limited to: (i) identifiers (IDs) specifying one or more primary blockchains as the source; (ii) IDs specifying identities (“identity IDs”) of one or more individuals whose information should be collected from the one or more primary blockchains; (iii) instructions for instantiating one or more sidechains to store the collected information; (iv) instructions for storing the collected information into one or more existing sidechains including IDs of the existing sidechains; (v) instructions for storing the collected information into a newly created sidechain; (vi) information specifying an association between the identity IDs; (vii) instructions for associating the collected information (discussed in more detail below in operation 306 or 308) using (vi); etc.

In some embodiments, the primary blockchains specified in the instructions may be one or more virtual spaces (e.g., the metaverse). Alternatively, the primary blockchains specified in the instructions may be blockchains created (e.g., by one or more components of the interpreter 102 of FIG. 1 such as the interpreter engine 210 of FIG. 2 in combination with a primary blockchain generation engine (not shown)) based on virtual space data stored in virtual space databases of one or more virtual spaces (e.g., metaverse data stored in a metaverse database of a metaverse). In some embodiments, prior to being stored within the primary blockchains, the virtual space data may be analysed and compiled (e.g., by the interpreter 102 of FIG. 1) into footprint data of individuals with virtual identities within the one or more virtual spaces on which a primary blockchain is based (e.g., from which the primary blockchain is generated from). In some embodiments, the virtual space data may be stored (within the primary blockchains) along with the generated footprint. The information to be collected from these primary blockchains may be the footprint data (within a primary blockchain) of one or more identities of the individual specified in the instructions.

As shown by operation 304 (marked with broken lines in FIG. 3 to indicate that this operation may be optional), the apparatus 200 may include means, such as communications hardware 206, interpreter engine 210, or the like, for obtaining permission to access the one or more primary blockchains identified based on the instructions discussed in operation 302. In some embodiments, permission to access these primary blockchains may not be needed. For example, permission may not be needed for publicly accessible blockchains (e.g., public blockchains) that do not implement any access restriction requirements. Alternatively, in some embodiments, permission may be required to access part or all of a primary blockchain. For example, permission may be required for privately-owned blockchains (e.g., private blockchains) that may store sensitive user data. Should permission be required, the permission may be obtained from a permission authority (e.g., an owner of the private blockchain). Permission to access a private blockchain may also be in the form of providing (e.g., by interpreter engine 210 through the communications hardware 206) a single-sign-on (SSO) authentication to the private blockchain. More specifically, the permission may be in the form of a username and password that is transmitted by the apparatus 200 to the private blockchain.

As shown by operation 306, the apparatus 200 may include means, such as communications hardware 206, interpreter engine 210, or the like, for obtaining footprint data (e.g., activity information) of one or more identities identified in the instructions from the one or more primary blockchains. The footprint data may be obtained by accessing one or more primary blockchains (also referred to as “source primary blockchains”) whose IDs are included in the instructions to collect data obtained in operation 302. For example, the interpreter engine 210 may retrieve the footprint data using various data retrieval processes (e.g., using a GET command, using one or more application programming interfaces (APIs) to fetch the data, etc.) transmitted to the source primary blockchain(s) by the communications hardware 206. As the source primary blockchain(s) are accessed, in embodiments, the retrieved footprint data may be temporarily stored in memory (e.g., memory 204) before being stored as a new block of a sidechain. Alternatively, the interpreter engine 210 may obtain the virtual space data stored in the primary blockchains and generate the footprint data using the obtained virtual space data (e.g., by analysing and compiling the virtual space data into the footprint data).

In some embodiments, when the instructions obtained in operation 302 include more than one identity ID (e.g., a first identity ID and a second identity ID), footprint data of the first identity ID may be associated with the first identity ID and footprint data of the second identity ID may be associated with the second identity ID. While the footprint data is being retrieved from the source primary blockchain(s), an association is also being generated between the first identity ID and the second identity ID. However, this association between the first identity ID and the second identity ID is not provided back (e.g., transmitted back) to the source primary blockchain(s). This advantageously ensures that the anonymity between the identity IDs that currently exists on the source primary blockchain is maintained.

In some embodiments, when the instructions obtained in operation 302 include several identity IDs (e.g., a first identity ID and a second identity ID) associated with different source primary blockchains (e.g., the first identity ID is associated with a first source primary blockchain and the second identity ID is associated with the second source primary blockchain), association information may be generated to tie (i.e., associate) these several identities to one another. This association indicates that the identity IDs may belong to a same entity, or that these identity IDs may belong to two entities who are related (e.g., a child and the child's guardian). However, yet again, this association information is not provided back (e.g., transmitted back) to the source primary blockchains. This again advantageously ensures that the anonymity between the identity IDs that currently exists on the source primary blockchains is maintained.

At operation 308, the apparatus 200 may include means, such as processor 202, memory 204, communications hardware 206, sidechain generation engine 212, or the like, for storing the footprint data retrieved in operation 306 into one or more sidechains. The sidechain generation engine 212 may organize and condense the retrieved footprint data (along with the generated association information) stored in the temporary storage into a data block to be stored in a sidechain. The generated data block may be transmitted by the communications hardware 206 (in response to instructions received from the sidechain generation engine 212) to a newly created or existing sidechain.

In some embodiments, the sidechain generation engine 212 may (in response to generating a data block containing footprint data) instantiate creation of a new sidechain in a private or public distributed network. The creation of the new sidechain may also be part of the instructions obtained in operation 302. In this example where a new sidechain is created, the generated data block may be stored as a genesis block of the newly created sidechain. Alternatively, if the instructions obtained in operation 302 instead includes instructions to store the footprint data in one or more existing sidechains, the sidechain generation engine 212 may cause the communications hardware 206 to transmit the generated data block storing the footprint data to the one or more existing sidechains using the IDs of the existing sidechains included in the instructions.

Each sidechain (whether existing or newly created) may be associated with a particular individual outside of the metaverse (e.g., an owner of the identities within the metaverse). Alternatively, each sidechain may be associated with multiple individuals (e.g., a child and the child's guardian).

By storing the footprint data on sidechains in decentralized network, computing resources of computing devices (e.g., apparatus 200) may be reduced due to the use of shared resources (the sidechains). For example, if an individual has larger number of identities (e.g., 50) and is consistently generating new activity information in primary blockchains every second, the amount of footprint data to be retrieved may exceed a storage capability of the memory 204 of the apparatus 200. Therefore, permanently storing such footprint data into sidechains that utilizes shared resources of multiple computing devices making up the decentralized network would directly improve the functionalities of apparatus 200 by reducing the amount of storage space necessary to store the footprint data.

In some embodiments, rather than generating the association information during the retrieval (e.g., obtaining) of the footprint data in operation 306, the association information may be generated in operation 308 by the sidechain generation engine 212 as the data block (genesis or subsequent block of a sidechain) is being generated. More specifically, the sidechain generation engine 212 may use any information (e.g., information specifying an association between the identity IDs) included in the instructions obtained in operation 302 to generate the association information.

In some embodiments, operations 306 and 308 discussed above may be done iteratively to keep one or more sidechains up to date by continuously and automatically retrieving footprint data from one or more source primary blockchains. This advantageously allows each sidechain to provide an up-to-date overview of an individual's (or multiple individuals') activities (i.e., behavior) in the virtual spaces, which may be used by one or more other entities to make more accurate and informed decisions for the individual(s). Such iteration of operations 306 and 308 may be included in the instructions obtained in operation 302.

Finally, as shown by operation 310, the apparatus 200 may include means, such as communications hardware 206, interpreter engine 210, or the like, for generating outputs based on the footprint data stored in the sidechains. The interpreter engine 210 may read and retrieve footprint data stored in one or more sidechains and transmit the retrieved footprint data (using the communications hardware 206) to one or more entities. Such retrieval and transmission may be done in response to a request for footprint data received from these one or more entities through the communications hardware 206.

In embodiments, the generated output may include the association information, between the multiple identity IDs, generated in operation 306 or 308. This advantageously allows an entity with access to this output to access a link between all of an individual's identities within the virtual spaces. This also allows the entity to access information specifying a relationship between two individuals (e.g., a child and a child's guardian) within the virtual spaces.

In embodiments, the generated outputs may be used as training data and/or input data for machine learning models (e.g., linear regression models, decision trees, artificial neural networks, etc.) to generate one or more inferences used to make decisions for the owner of the footprint data. For example, a bank may want to track footprint data of a client traversing through the metaverse using multiple identities. The footprint data of each (or some) of the client's multiple identities in the metaverse may be stored in a sidechain. This footprint data may then be retrieved from the sidechain to be used in a machine learning model trained generate one or more decisions associated with the client (e.g., provide the client with more access to the banks financial services in a specific virtual space where the client has the most activity, providing the client with new financial services/options based on the client's risk behavior within the virtual spaces, etc.).

As described above, example embodiments provide methods and apparatuses that enable improved use of hardware resources, use of underutilized data, and/or accessibility to data. Example embodiments thus provide tools that overcome the problems faced by identifying where and how individuals have traversed through a virtual space. By understanding where and how individuals have traversed through a virtual space, example embodiments are able to provide information (e.g., footprint data) that can help entities make more informed and accurate decisions for these individuals using these individuals' activities in the virtual spaces. Storage of such footprint data in sidechains established within decentralized networks advantageously saves computing resources of the computing device(s) gathering the data while also eliminating the possibility of overexerting storage resources of these computing device(s).

As these examples all illustrate, example embodiments contemplated herein provide technical solutions that solve real-world problems faced as individuals shift more of their time to virtual spaces. In particular, such shift result in the behavior of these individuals within these virtual spaces to become more useful resources as the individual's virtual behavior may be correlated with the individual's behavior in the real world. And while tracking an individual's activities in virtual spaces (e.g., the Internet, etc.) has always been an issue, the recently exploding amount of data made available by recently emerging technology today has made this problem significantly more acute, as the demand for information related to the individual's virtual activities has grown significantly. At the same time, example embodiments described herein has unlocked new avenues to solving this problem that historically were not available, and thus example embodiments described herein represent a technical solution to these real-world problems.

FIG. 3 illustrates operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### Example Primary Blockchain and Sidechain Configurations

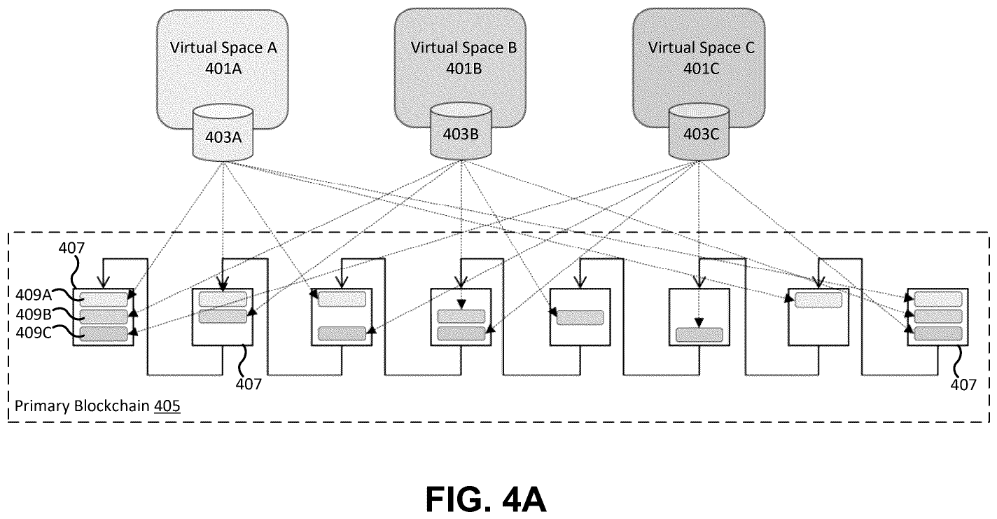

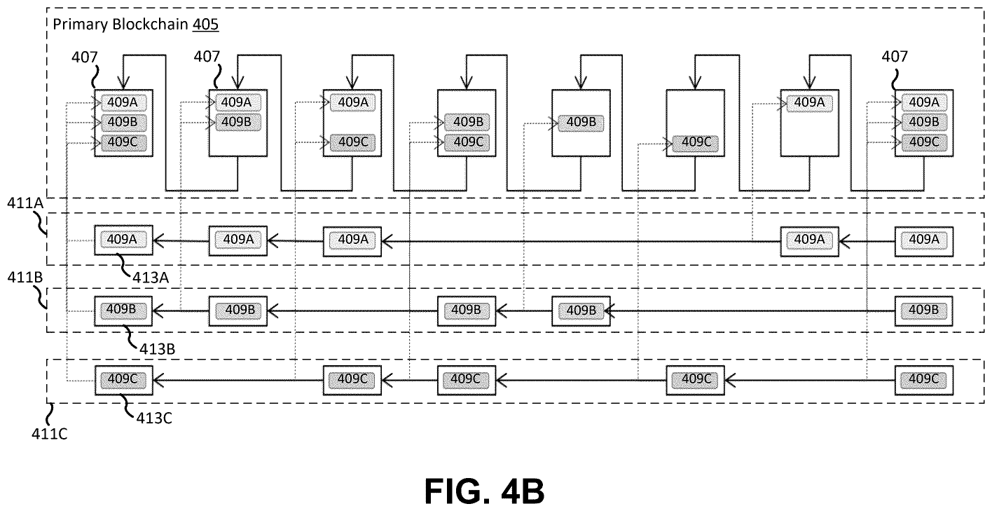

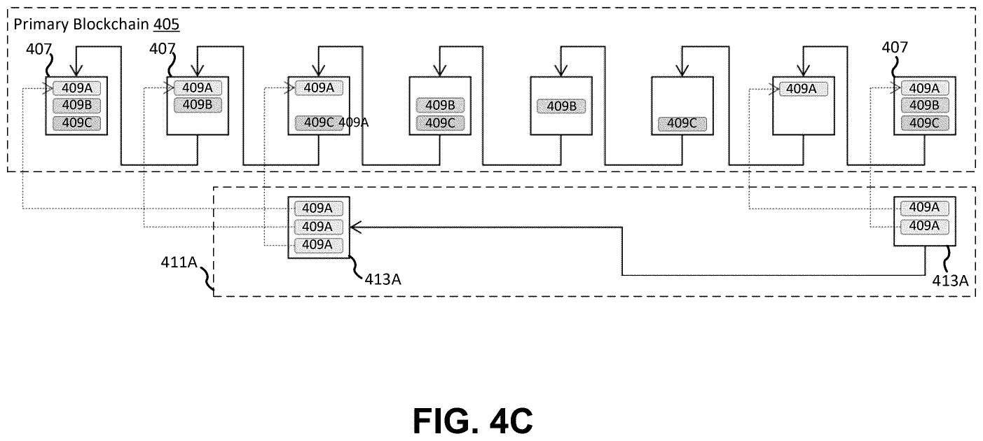

FIGS. 4A-4C show implementation examples of embodiments disclosed herein. More specifically, FIGS. 4A-4C show the generation of primary blockchains and sidechains from one or more virtual spaces. In each of FIGS. 4A-4C, an arrow with solid lines shows a direct connection between components (e.g., that the components are directly connected to one another) while an arrow with broken lines shows an indirect link between (e.g., an association established between) components.

Turning first to FIG. 4A, FIG. 4A shows an environment having three virtual spaces 401A-401C. These virtual spaces 401A-401C include virtual space databases 403A-403C, respectively. As further shown in FIG. 4A, a primary blockchain 405 is generated based on virtual spaces 401A-401C. The primary blockchain 405 includes a plurality of primary blockchain blocks 407. Each of these primary blockchain blocks 407 of the primary blockchain 405 are configured to store footprint data 409A-409C. The footprint data 409A-409C may be generated using virtual space data stored in respective ones of the virtual space databases 403A-403C. For example, footprint data 409A is generated using virtual space data from virtual space database 403A. Each primary blockchain block 407 is generated (e.g., published on the primary blockchain 405) based on specific events (e.g., to record specific events such as daily login and logoff, promotions, awards, transactions, or the like) associated with a virtual identity (e.g., an avatar of an individual) in one of the virtual spaces 401A-401C. For example, the first instance of footprint data 409A (e.g., the instance on the very left side of FIG. 4A) is a recordation of a log-in action by an individual while the final instance (e.g., the instance on the very right side of FIG. 4A) is a recordation of a log-off action by the individual.

Turning now to FIG. 4B, three sidechains 411A-411C are generated using primary blockchain 405 as a base. Each of the three sidechains 411A-411C may include multiple sidechain blocks 413A-413C. Each sidechain block 413A-413C may be used to store footprint data 409A-409C stored in the primary blockchain 405. For example, sidechain 411A is generated to store only footprint data 409A, sidechain 411B is generated to store only footprint data 409B, and sidechain 411C is generated to store only footprint data 409C. Each sidechain block 413A-413C may be generated upon detection (e.g., by interpreter 102) that corresponding footprint data 409A-409C has been added (e.g., stored) into one or more primary blockchain blocks 407 of the primary blockchain.

Finally, turning to FIG. 4C, FIG. 4C shows an example where multiple footprint data is stored in a single sidechain block of a sidechain. More specifically, as seen in FIG. 4C, a sidechain 411A includes two sidechain blocks 413A each storing multiple ones of the footprint data 409A obtained from the primary blockchain 405. Such sidechain 411A shown in FIG. 4C where footprint data is stored in a single sidechain block may be referred to as an “index sidechain.”

### Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
receiving, by communication hardware of an interpreter, instructions to instantiate a sidechain;
obtaining, by an interpreter engine of the interpreter and as part of instantiating the sidechain, first footprint data from a first primary blockchain and second footprint data from a second primary blockchain different from the first primary blockchain, wherein the first footprint data is associated with a first identity on the first primary blockchain and the second footprint data is associated with a second identity on the second primary blockchain;
instantiating, by a sidechain generation engine of the interpreter, the sidechain, wherein the sidechain comprises association information between the first identity and the second identity, and wherein the association information is secured in the sidechain without being provided back to either the first primary blockchain or the second primary blockchain;
storing, by the sidechain generation engine, the first footprint data and the second footprint data in the sidechain;
training, by the sidechain generation engine, a machine learning model based on a first output, wherein the first output is generated based on the first footprint data and the second footprint data; and
generating, by the sidechain generation engine and based on the first output, an inference associated with a client, wherein the inference represents a decision associated with the client.

2. The method of claim 1, wherein the first identity comprises first activity information associated with activities of the first identity within the first primary blockchain and the second identity comprises second activity information associated with activities for the second identity within the second primary blockchain.

3. The method of claim 2, further comprising:
causing, by the sidechain generation engine and on a display, generation of a first output based on the first footprint data and the second footprint data stored in the sidechain.

4. The method of claim 3, wherein the first output comprises the association information between the first identity and the second identity.

5. The method of claim 4, wherein the first identity and the second identity are associated with a same entity.

6. The method of claim 4, wherein the first identity and the second identity are associated with different entities.

7. The method of claim 1, wherein instantiating the sidechain comprises generating, by the sidechain generation engine, the association information between the first identity and the second identity and storing the association information in the sidechain, and wherein the sidechain generation engine generates the association information using the instructions to instantiate the sidechain.

8. The method of claim 1, further comprising: generating, by the interpreter, the first primary blockchain based on a first virtual space and the second primary blockchain based on a second virtual space different from the first virtual space, wherein the first primary blockchain stores virtual space data of the first virtual space and the second primary blockchain stores virtual space data of the second virtual space.

9. The method of claim 1, wherein the instructions to instantiate the sidechain comprises instructions to instantiate the sidechain as a new sidechain on a network.

10. The method of claim 1, wherein the instructions instantiate the sidechain comprises instructions to instantiate a new sidechain block in an existing sidechain on a network.

11. An apparatus comprising:
communication hardware configured to receive instructions to instantiate a sidechain;
an interpreter engine configured to obtain, as part of instantiating the sidechain, first footprint data from a first primary blockchain and second footprint data from a second primary blockchain different from the first primary blockchain, wherein the first footprint data is associated with a first identity on the first primary blockchain and the second footprint data is associated with a second identity on the second primary blockchain; and
a sidechain generation engine configured to:
instantiate the sidechain, wherein the sidechain comprises association information between the first identity and the second identity, and wherein the association information is secured in the sidechain without being provided back to either the first primary blockchain or the second primary blockchain,
store the first footprint data and the second footprint data in the sidechain,
train a machine learning model based on a first output, wherein the first output is generated based on the first footprint data and the second footprint data, and
generate, based on the first output, an inference associated with a client, wherein the inference represents a decision associated with the client.

12. (canceled)

13. The apparatus of claim 11, wherein the sidechain generation engine is further configured to:
cause, on a display, generation of a first output based on the first footprint data and the second footprint data stored in the sidechain.

14. The apparatus of claim 13, wherein the first output comprises the association information between the first identity and the second identity.

15. The apparatus of claim 11, wherein instantiating the sidechain comprises generating, by the sidechain generation engine, the association information between the first identity and the second identity and storing the association information in the sidechain.

16. A computer program product comprising at least one non-transitory computer-readable storage medium storing software instructions that, when executed, cause an apparatus to:
receive, by communication hardware of the apparatus, instructions to instantiate a sidechain;
obtain, by an interpreter engine and as part of instantiating the sidechain, first footprint data from a first primary blockchain and second footprint data from a second primary blockchain different from the first primary blockchain, wherein the first footprint data is associated with a first identity on the first primary blockchain and the second footprint data is associated with a second identity on the second primary blockchain;
instantiate, by a sidechain generation engine and based on the instructions the sidechain, wherein the sidechain comprises association information between the first identity and the second identity, and wherein the association information is secured in the sidechain without being provided back to either the first primary blockchain or the second primary blockchain;
store, by the sidechain generation engine, the first footprint data and the second footprint data in the sidechain;
train, by the sidechain generation engine, a machine learning model based on a first output, wherein the first output is generated based on the first footprint data and the second footprint data; and
generate, by the sidechain generation engine and based on the first output, an inference associated with a client, wherein the inference represents a decision associated with the client.

17. (canceled)

18. The computer program product of claim 16, wherein the apparatus is further caused to, by the sidechain generation engine and on a display, generate a first output based on the first footprint data and the second footprint data stored in the sidechain.

19. The computer program product of claim 18, wherein the first output comprises the association information between the first identity and the second identity.

20. The computer program product of claim 16, wherein instantiating the sidechain comprises generating, by the sidechain generation engine, the association information between the first identity and the second identity and storing the association information in the sidechain.

21. The method of claim 1, wherein the first identity and the second identity are associated with a same user.

22. The method of claim 1, wherein the first identity is associated with a first user and the second identity is associated with a second user, wherein the second user is different from the first user.
